(19) United States
(12) Patent Application Publication
(10) Pub. No.: US 2023/0222598 A1
(43) Pub. Date: Jul. 13, 2023

(54) SYSTEMS AND METHODS FOR TELEMATICS-CENTRIC RISK ASSESSMENT

(71) Applicant: ALLSTATE INSURANCE COMPANY, Northbrook, IL (US)

(72) Inventors: Anuradha KODALI, Freemont, CA (US); Marco De Virgilis, Chicago, IL (US); Timothy W. Gibson, Barrington, IL (US)

(21) Appl. No.: 17/574,339

(22) Filed: Jan. 12, 2022

(51) Int. Cl. G06Q 40/08; G07C 5/08; G06Q 50/00

(52) U.S. Cl. CPC G06Q 40/08; G07C 5/0816; G07C 5/0841; G06Q 50/01

(57) ABSTRACT

Implementations described and claimed herein provide systems and methods for risk assessment. In one implementation, a telematics-centric driving risk value is generated for a specific individual by determining one or more demographic segments corresponding to the specific individual and calculating one or more risk factor values associated with the one or more demographic segments using telematics data. A telematics-weighted personalized risk value is generated by: determining one or more telematics metrics from the telematics data; calculating a telematics persona risk value based on the one or more telematics metrics; calculating a behavioral persona risk value based on one or more behavioral metrics; calculating a household persona risk value based on one or more household metrics; and calculating a finance persona risk value based on one or more finance metrics. A telematics-centric risk prediction value is generated based on the telematics-centric driving risk value and the telematics-weighted personalized risk value.

### FIELD

Aspects of the presently disclosed technology relate generally to risk assessment and more particularly to generating a telematics-centric rating for an individual with an emphasis on individual risk using telematics data.

### BACKGROUND

Risk for an individual, such as individual driving risk, may be determined in a variety of manners. Often, demographics metrics are used as a proxy to individual risk. For example, territory may be used to identify individuals with similar risk traits, such as that a predicted risk for a similarly situated individual may be used as a proxy for another individual. However, in many contexts, multiple individuals may be analyzed as a group under a single risk assessment, artificially skewing such metrics and complicating assessment at an individual level. As such, many risk predictions fail to capture correlations between individual-level driving data, household composition, and other facets of the individual that impact risk. It is with these observations in mind, among others, that various aspects of the present disclosure were conceived and developed.

### SUMMARY

Implementations described and claimed herein address the foregoing by providing systems and methods for generating a telematics-centric risk assessment. In one implementation, telematics data associated with a specific individual is obtained. A telematics-centric driving risk value is generated for the specific individual by determining one or more demographic segments corresponding to the specific individual and calculating one or more risk factor values associated with the one or more demographic segments using the telematics data. A telematics-weighted personalized risk value is generated by: determining one or more telematics metrics from the telematics data; calculating a telematics persona risk value based on the one or more telematics metrics; calculating a behavioral persona risk value based on one or more behavioral metrics; calculating a household persona risk value based on one or more household metrics; and calculating a finance persona risk value based on one or more finance metrics. A telematics-centric risk prediction value is generated based on the telematics-centric driving risk value and the telematics-weighted personalized risk value.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for generating a telematics-centric risk prediction value.

FIG. 2 illustrates an example system for generating a telematics-centric driving risk value used for generating a telematics-centric risk prediction value.

FIG. 3 illustrates an example system for generating a telematics-centric driving risk value used for generating a telematics-centric risk prediction value.

FIG. 4 illustrates an example system for generating a telematics-weighted personalized risk value used for generating a telematics-centric risk prediction value.

FIG. 5 illustrates an example insurance policy generating system for selecting a risk prediction value.

FIG. 6 illustrates an example network environment for generating a telematics-centric risk prediction value.

FIG. 7 illustrates example computing architectures for generating a telematics-centric risk prediction value.

FIG. 8 illustrates example operations of a method for generating a telematics-centric risk prediction value.

### DETAILED DESCRIPTION

Aspects of the present disclosure involve systems and methods for generating a telematics-centric risk assessment. Generally, the presently disclosed technology predicts individual risk, such as driving risk, personality risk, and/or the like, using a rating plan layered around telematics variables segmented with demographics and behavior information. In some cases, individual user metrics may be leveraged with the telematics variables to compensate for personality risk in a rating plan based on territory metrics, demographics metrics, finance metrics, and other risk metrics. As such, telematics becomes the central theme in risk assessment including telematics variables intertwined with demographics metrics addressing an otherwise lack of individual risk assessment at a policy-level. The individual risk may include the driving risk and personalized risk for an individual. Driving risk (telematics risk) may use telematics rating variables, including, but not limited to, mileage, hard breaking, speeding, and/or the like, segmented into demographic categories. Personality risk may be divided into various personas, including, without limitation, a telematics persona, household persona, behavioral persona, finance persona, and/or the like. First rate pricing may be determined as a function of the driving risk and personality risk and evaluated in direct comparison with second rate pricing generated based on territory.

In one aspect, a system includes a telematics-centric risk prediction model which receives multiple different types of data associated with a specific individual and analyzes the different types of data to generate a telematics-centric risk prediction value. For instance, the telematics-centric risk prediction model receives telematics data, demographics data, and persona metrics related to the specific individual and uses various techniques to analyze the data at different layers of granularity and calculate multiple different prediction factors. The multiple different prediction factors are combined to generate the telematics-centric risk prediction value, integrating the telematics data into a rating at the individual risk level and improving the accuracy and granularity of the risk prediction for the rating.

For example, the telematics-centric risk prediction model can generate a telematics-centric driving risk value based on the telematics data and a plurality of demographic segments corresponding to the specific individual. A piece-wise model can be used to generate the telematics-centric driving risk value by calculating a plurality of risk factor values associated with the plurality of demographic segments. Additionally or alternatively, an aggregated model can be used to generate the telematics-centric driving risk value by aggregating the plurality of demographic segments into a demographic model, and using the demographic model to calculate a single risk factor value.

The system may generate a telematics-weighted personalized risk value. For instance, the telematics-centric risk prediction model can generate a plurality of personas based on various persona metrics associated with the specific individual. The plurality of personas can include a telematics persona, a household persona, a behavioral persona, and a finance persona. Persona risk values corresponding to the plurality of personas (e.g., a telematics persona risk, a household persona risk, a behavioral persona risk, and a finance persona risk) can be calculated and aggregated to generate the telematics-weighted personalized risk value. Once the telematics-weighted personalized risk value is generated, it is combined with the telematics-centric driving risk value to generate the telematics-centric risk prediction value. Furthermore, a territory-based risk prediction value can be generated and used with the telematics-centric risk prediction value to calculate a feedback ratio, which can form the basis for selecting one of the risk prediction values and improving the accuracy of the telematics-centric risk prediction model.

The telematics-centric risk prediction model can be fine-tuned to improve determinations regarding which telematics-related factors most strongly impact the predicted risk (e.g., by using the feedback ratio). Accordingly, the systems discussed herein generate a more accurate risk prediction value by incorporating the telematics data at various levels of the analytics data flow. Additional advantages of the presently disclosed technology will become apparent from the detailed description below.

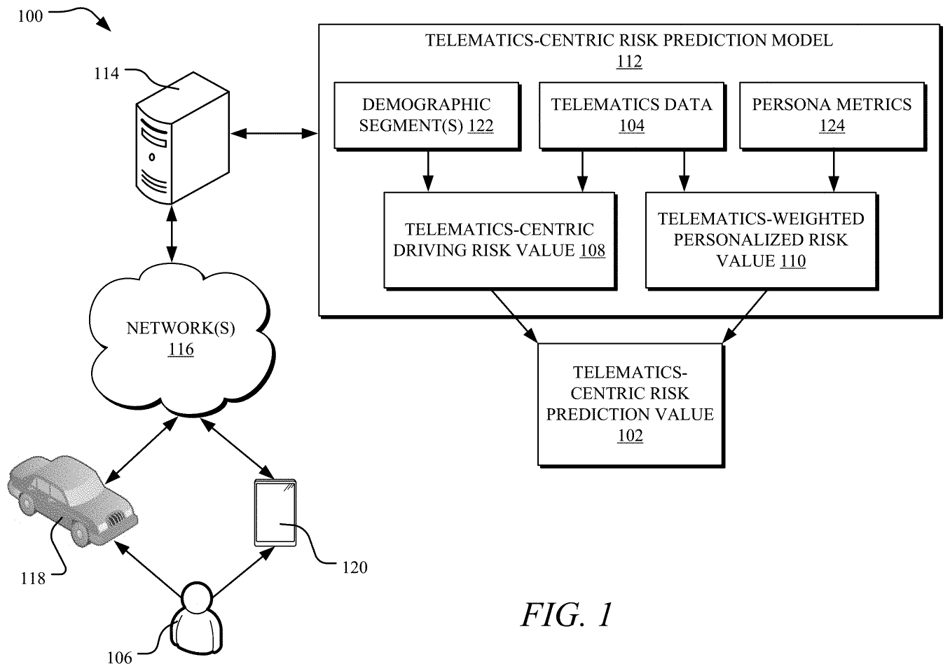

To begin a detailed description of an example system 100 for generating a telematics-centric risk prediction value 102, reference is made to FIG. 1. In one implementation, the system 100 uses telematics data 104 associated with a specific individual 106 (e.g., a person receiving or applying for an insurance policy) to generate multiple prediction factors which are used to calculate the telematics-centric risk prediction value 102. The telematics data 104 may be captured using a telematics device and/or one or more vehicle sensors associated with a vehicle and/or the specific individual. The telematics data 104 may be captured during an operation of the vehicle. The prediction factors include a telematics-centric driving risk value 108 and a telematics-weighted personalized risk value 110. Both of these prediction factors are used by a telematics-centric risk prediction model 112 to generate the telematics-centric risk prediction value 102, improving the risk prediction model over territory-based prediction models, which, in some instances, only use telematics data 104 to determine community trends.

The system 100 can generate the telematics-centric driving risk value 108 and the telematics-weighted personalized risk value 110 using a variety of information received, for instance, at a server device 114 of an insurance provider via one or more network(s) 116. A vehicle 118 with one or more telematic sensors (e.g., a global positioning system (GPS) sensor, a global navigation satellite system (GNSS), an onboard computer tracking systems, etc.) can generate and/or send the telematics data 104 to the server device 114. Additionally or alternatively, the telematics data 104 can originate and/or be received from a mobile device 120 associated with the specific individual 106. Moreover, the telematics-centric risk prediction model 112 can receive and use other information in conjunction with the telematics data 104 for calculating the prediction factors of the telematics-centric risk prediction model 112. The system 100 can receive and/or generate data representing one or more demographic segment(s) 122 corresponding to the specific individual 106, which can be used with the telematics data 104 to generate the telematics-centric driving risk value. Additionally, the telematics-centric risk prediction model 112 can receive and/or generate data representing one or more persona metric(s) 124, which can be used with the telematics data 104 to generate the telematics-weighted personalized risk value 110.

As discussed herein, the system 100 incorporates the telematics data 104 into the risk prediction process at multiple steps of data aggregation and analysis for generating the telematics-centric risk prediction value 102. As such, the resultant telematics-centric risk prediction value 102 accounts for the risk associated with the telematics data 104 in a more accurate, granular, and tunable manner for optimized individual rating.

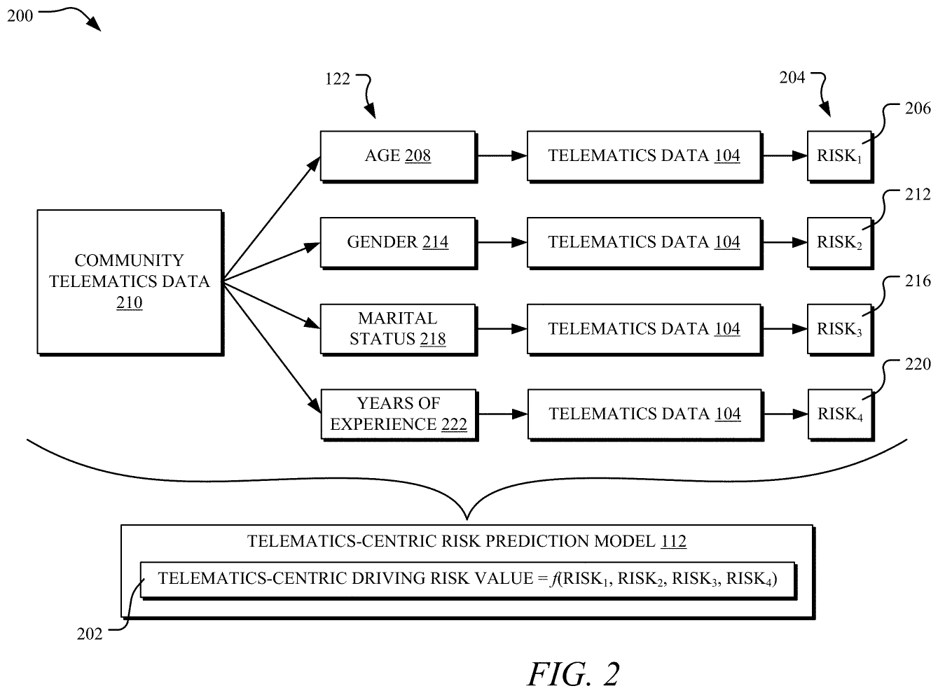

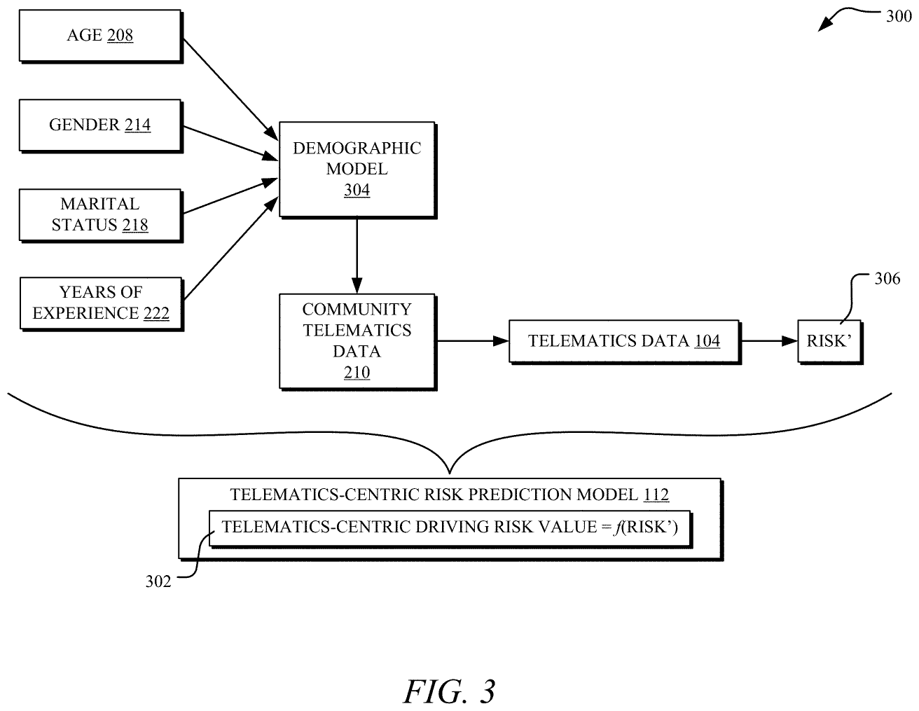

Turning to FIG. 2, an example system 200 for generating the telematics-centric driving risk value 108 prediction factor of the telematics-centric risk prediction value 102 is illustrated. The system 200 depicted in FIG. 2 illustrates a “piece-wise” model 202 for generating the telematics-centric driving risk value 108 in that a plurality of risk factor values 204 are calculated separately, each corresponding to one of the plurality of demographic segment(s) 122. In contrast, FIG. 3 illustrates an “aggregated” model 302 for generating the telematics-centric driving risk value 108.

As can be understood from FIG. 2, the telematics-centric risk prediction model 112 can calculate one or more risk factors, such as the plurality of risk factor values 204, that correspond to the demographic segment(s) 122. For instance, a first risk factor value 206 can be calculated for a first demographic segment 208. The first demographic segment 208 can be an age segment. For instance, the telematics-centric risk prediction model 112 determines an age associated with the specific individual 106 (e.g., based on an input provided by the specific individual 106). The first demographic segment 208, or age segment, represents an age or age range corresponding to the age associated with specific individual 106. For instance, the specific individual 106 may be 29 years old and the first demographic segment 208 may represent 29 years and/or a range including the age of the specific individual 106, such as a range of 25-30 years, 25-35 years, and the like.

Upon determining the age segment corresponding to the age of the specific individual 106, the telematics-centric risk prediction model 112 can determine community telematics data 210 corresponding to the age segment. The telematics-centric risk prediction model 112 can receive and/or store the community telematics data 210 representing telematic information for a variety of multiple insurance policy holders associated with a particular region or territory (e.g., a location, region, or territory associated with the specific individual 106). To perform the steps discussed herein, the community telematics data 210 can be filtered and/or aggregated according to the demographic segment(s) 122 to identify portions or subgroups of the community telematics data 210 relevant to the demographic segment(s) 122. A risk value associated with the policy holders of a first subgroup is determined (e.g., based on historical risk calculations and/or a driving or policy history of the policy holders). Additionally, the telematics data 104 of the specific individual 106 is compared to the subgroup of the community telematics data 210 corresponding to the age segment to determine whether the telematics data 104 of the specific individual 106 represents more risk or less risk—and to what extent—than the subgroup of the community telematics data 210 corresponding to the age segment. The previously determined risk of the policy holders of the subgroup along with the results of the telematics data 104 comparison can be used to calculate the first risk factor value 206 for the specific individual 106. For instance, the telematics data 104 comparison may indicate that the telematics data 104 of the specific individual 106 represents a greater risk than the subgroup of the community telematics data 210 corresponding to the first demographic segment 208 or age segment (e.g., 20% more risky). As such, the first risk factor value 206 is calculated by modifying (e.g., increasing) the risk associated with the subgroup of the community telematics data 210 to match the difference determined by the comparison (e.g., increased by 20%).

In some examples, a second risk factor value 212 can be calculated for a second demographic segment 214, such as a gender segment. For instance, the telematics-centric risk prediction model 112 determines a gender associated with the specific individual 106 (e.g., based on the input provided by the specific individual 106). The second demographic segment 214, or gender segment, represents the gender corresponding to the specific individual 106. For instance, the specific individual 106 may be a male and the second demographic segment 214 may represent males. As such, the telematics-centric risk prediction model 112 determines the community telematics data 210 corresponding to the second demographic segment 214 (e.g., the male policy holders in the territory or region). The telematics data 104 associated with the specific individual 106 is compared to a second subgroup of the community telematics data 210 corresponding to the second demographic segment 214. Accordingly, a risk associated with policy holders of the second subgroup is determined and modified to reflect the results of the comparison, generating the second risk factor value 212.

In some examples, a third risk factor value 216 can be calculated for a third demographic segment 218, such as a marital status segment. For instance, the telematics-centric risk prediction model 112 determines a marital status associated with the specific individual 106 (e.g., based on the input provided by the specific individual 106). The third demographic segment 218, or marital status segment, represents the marital status corresponding to the specific individual 106. For instance, the specific individual 106 may be married and the third demographic segment 218 may represent married people. As such, the telematics-centric risk prediction model 112 determines the community telematics data 210 corresponding to the third demographic segment 218 (e.g., the married policy holders in the territory or region). The telematics data 104 associated with the specific individual 106 is compared to a third subgroup of the community telematics data 210 corresponding to the third demographic segment 218. Accordingly, a risk associated with policy holders of the third subgroup is determined and modified to reflect the results of the comparison, generating the third risk factor value 216.

In some examples, a fourth risk factor value 220 can be calculated for a fourth demographic segment 222, such as a years of experience segment. For instance, the telematics-centric risk prediction model 112 determines a number of years of driving experience associated with the specific individual 106 (e.g., based on the input provided by the specific individual 106). The fourth demographic segment 222, or years of experience segment, represents the driving experience corresponding to the specific individual 106. For instance, the specific individual 106 may have 12 years of driving experience and the fourth demographic segment 222 may represent people having the same driving experience or within a similar range of driving experience (e.g., 8-12 years, 10-15 years, 10-20 years, or the like). As such, the telematics-centric risk prediction model 112 determines the community telematics data 210 corresponding to the fourth demographic segment 222 (e.g., the policy holders having same or similar driving experience in the territory or region). The telematics data 104 associated with the specific individual 106 is compared to a fourth subgroup of the community telematics data 210 corresponding to the fourth demographic segment 222. Accordingly, a risk associated with policy holders of the fourth subgroup is determined and modified to reflect the results of the comparison, generating the fourth risk factor value 220.

As noted above, the telematics-centric risk prediction model 112 can include the piece-wise model 202 for calculating the telematics-centric driving risk value 108. For instance, the telematics-centric risk prediction model 112 can calculate the plurality of risk factor values 204 individually for the different demographic segment(s) 122, and the telematics-centric driving risk value 108 can be calculated based on the plurality of risk factor values 204 (e.g., a summation of the plurality of risk factor values 204). In some instances, two or more demographic segments 122 can be used to generate two or more risk factor values 204. As such, according to the piece-wise model 202, the telematics-centric driving risk value 108 can be calculated as a function of the first risk factor value 206, the second risk factor value 212, the third risk factor value 216, and the fourth risk factor value 220.

As depicted in FIG. 3, a system 300 can include the telematics-centric risk prediction model 112 using the aggregated model 302 to generate the telematics-centric driving risk value 108, additionally or alternatively to using the piece-wise model 202. For instance, the telematics-centric risk prediction model 112 can combine the first demographic segment 208 (e.g., the age segment), the second demographic segment 214 (e.g., the gender segment), the third demographic segment 218 (e.g., the marital status segment), the fourth demographic segment 222 (e.g., the years of experience segment), and/or any number of demographic segments to form a demographic model 304. The demographic model 304 represents the plurality of demographic segments 122 associated with the specific individual 106.

In some instances, the demographic model 304 can be used to identify a subgroup of the community telematics data 210 that corresponds to the demographic segment(s) 122. The subgroup of the community telematics data 210 can be associated with policy holders in the particular territory or region that share similar or identical demographic characteristics as the demographic model 304 (e.g., and the plurality of demographic segment(s) 122). By way of example, the demographic model 304 can represent a 29-year-old male that is married and has twelve years of driving experience. In this example, the telematics-centric risk prediction model 112 uses the demographic model 304 to identify the subgroup of the community telematics data 210 corresponding to other policy holders in the territory or region with similar or identical demographic characteristics, namely other approximately 29 year-old males that are married with approximately twelve years of driving experience. The subgroup of the community telematics data 210 can be compared to the telematics data 104 of the specific individual 106 to determine how a risk associated with the telematics data 104 compares to the risk associated with the subgroup of the community telematics data 210. The risk factor value 306 is generated by modifying the risk associated with the subgroup of the community telematics data 210 to reflect the results of this comparison. As such, by using the aggregated model 302, the plurality of demographic segments 122 can be aggregated and used to generate a single risk factor value 306. According to the aggregated model 302 the telematics-centric driving risk value 108 is a function of the single risk factor value 306.

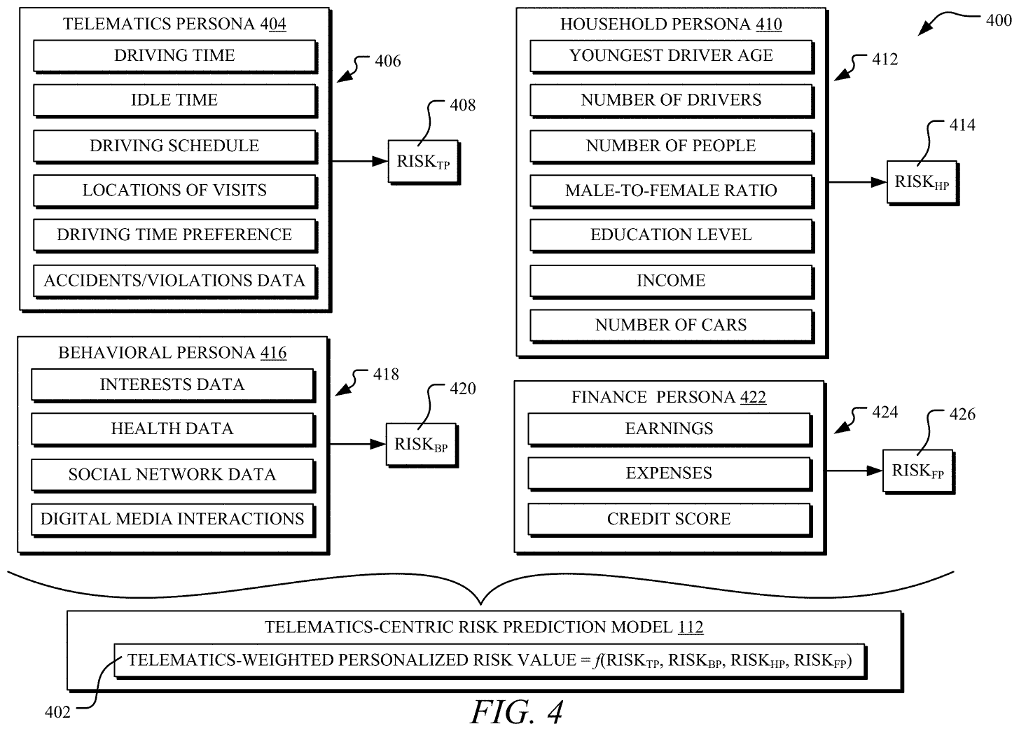

FIG. 4 illustrates an example system 400 for generating the telematics-weighted personalized risk value 110 used to calculate the telematics-centric risk prediction value 102. The telematics-centric risk prediction model 112 can include a persona model 402 for determining the telematics-weighted personalized risk value 110 based on various persona risk values associated with the specific individual 106.

In some examples, the telematics-centric risk prediction model 112 generates a telematics persona 404. The telematics persona 404 can be generated based on the telematics data 104, such as one or more telematics metrics 406 or telematics-related metrics, which can be received in the telematics data 104 and/or generated by the telematics-centric risk prediction model 112 from the telematics data 104. The one or more telematics metrics 406 can be scored, rated, and/or compared to baseline or average values to determine a telematics persona risk value 408. For instance, artificial intelligence such as supervised machine learning, neural networks, and other algorithms or techniques may be trained through one or more iterative and validation processes using historical telematics data, policy holder data, risk values associated with the policy holder data, outcomes associated with the policy holder data, and the like to calculate a plurality of telematics persona risk values for a plurality of telematics personas. These risk values can be ranked relative to each other and/or to standardized risk pricing metrics.

The telematics persona risk value 408 can represent how the individual telematics metrics 406 correlate to risk. For instance, a greater amount of driving time (e.g., relative to other personas of other individuals) corresponds to a higher telematics persona risk value 408; certain locations may be associated with higher or lower telematics persona risk value 408 (e.g., high-speed, single-lane highways are high risk, slow areas near schools are low risk); a night time driving preference can be associated with high telematics persona risk value 408; and a day time driving preference can be associated with a low telematics persona risk value 408. The one or more telematics metrics 406 analyzed and used to determine the telematics persona risk value 408 include one or more of a driving time, an idle time, a driving schedule, one or more locations of visit(s), a driving time preference, accidents-related data, violations-related data, combinations thereof, and the like. In some instances, two or more of the plurality of telematics metrics 406 can be used to generate the telematics persona risk value 408. It is to be understood that the terms “high” and “low” as used herein can represent numerical valuations generated by the analysis, such as a binary “1” for “high” and a “0” for low; a three-tiered tiered rating system (e.g., “low,” “medium,” and “high”), four-tiered rating system, five-tiered rating system, any type of numerical scale or normalized rating, a heuristic rating system, and the like.

In some examples, the telematics-centric risk prediction model 112 can use the persona model 402 to generate a household persona 410 based on one or more household persona metric(s) 412. The household persona metric(s) 412 represent various aspects and characteristics of a household associated with the specific individual 106. A household persona risk value 414 can be calculated from the household persona 410, for instance, using supervised machine learning, neural networks, and other algorithms or techniques trained through one or more iterative and validation process, as discussed above regarding the telematics persona risk value 408. The one or more household persona metric(s) 412 can include one or more of a youngest driver age associated with the household, a number of drivers associated with the household, a number of people associated with the household, a male-to-female ratio (e.g., a number of males, a number of females, etc.) associated with the household, an education level associated with the household, an income level associated with the household, a number of cars associated with the household, or the like. The one or more household persona metric(s) 412 are used to calculate the household persona risk value 414 representing how the aspects and characteristics of the household affect the risk associated with the specific individual 106.

In some instance, the telematics-centric risk prediction model 112 can use the persona model 402 to generate a behavioral persona 416 based on one or more behavioral persona metric(s) 418. The behavioral persona metric(s) 418 represent various aspects and characteristics of the behavior or personality associated with the specific individual 106. A behavioral persona risk value 420 can be calculated from the behavioral persona 416, for instance, using supervised machine learning, neural networks, and other algorithms or techniques trained through one or more iterative and validation process, as discussed above regarding the telematics persona risk value 408. The one or more behavioral persona metrics 420 can include one or more of interests data representing hobbies or personal interests of the specific individual 106; health data (e.g., received as user input and/or from a wearable device monitoring the specific individual 106) representing health information of the specific individual 106; social network data representing social connections of the specific individual 106, digital media interactions data representing “likes,” comments, downloads, streams, or other online activity, or the like. The one or more behavioral persona metric(s) 418 are used to calculate the behavioral persona risk value 420 representing how the behavior of the specific individual 106 affects the risk associated with the specific individual 106.

In some instance, the telematics-centric risk prediction model 112 can use the persona model 402 to generate a finance persona 422 based on one or more finance persona metric(s) 424. The finance persona metric(s) 424 represent various aspects and characteristics of the financial status and financial history associated with the specific individual 106. A finance persona risk value 426 can be calculated from the finance persona 422, for instance, using supervised machine learning, neural networks, and other algorithms or techniques trained through one or more iterative and validation process, as discussed above regarding the telematics persona risk value 408. The one or more finance persona metrics 424 can include one or more earnings data associated with the specific individual 106, expenses data associated with the specific individual 106, a credit score associated with the specific individual 106, or the like. The one or more finance persona metric(s) 424 are used to calculate the finance persona risk value 426 representing how the financial status of the specific individual 106 affects the risk associated with the specific individual 106.

In some instance, the system 400 can determine a combination of correlations between the various persona metrics and the telematics persona risk value 408, the household persona risk value 414, the behavioral persona risk value 420 and/or the finance persona risk value 426. For example, the system 400 may utilize one or more pattern recognition algorithms to correlate persona metrics with various generated risk values and, through a regression algorithm, may train/validate the telematics-centric risk prediction model 112 with a recursive input data set. A process of model generation, regression, validation, and alteration may be repeated until a determined error of the telematics-centric risk prediction model 112 falls below a threshold value (e.g., by comparing test run results to historical data). In this manner, the telematics-centric risk prediction model 112 may utilize techniques (e.g., the one or more pattern recognition algorithms) to generate the risk values from the persona metrics and accurately predict risk for the specific individual 106.

The telematics-centric risk prediction model 112 can generate and aggregate (e.g., sum, multiple, weigh, or otherwise use) the telematics persona risk value 408, the household persona risk value 414, the behavioral persona risk value 420, and/or the finance persona risk value 426 to generate the telematics-weighted personalized risk value 110. In other words, the persona model 402 can determine the telematics-weighted personalized risk value 110 as a function of the telematics persona risk value 408, the household persona risk value 414, the behavioral persona risk value 420, and/or the finance persona risk value 426.

The various persona metrics discussed herein (e.g., the telematics persona risk value 408, the household persona risk value 414, the behavioral persona risk value 420, and/or the finance persona risk value 426) can be received by the telematics-centric risk prediction model 112 via one or more inputs from the specific individual 106 (e.g., at the mobile device 120 and/or at another computing device associated with the specific individual 106). Additionally or alternatively, one or more application programming interfaces (API)s of the telematics-centric risk prediction model 112 can send requests to other APIs (e.g., of social networks, credit rating agencies, publicly available databases, etc.) and/or receive the persona metrics from the other APIs.

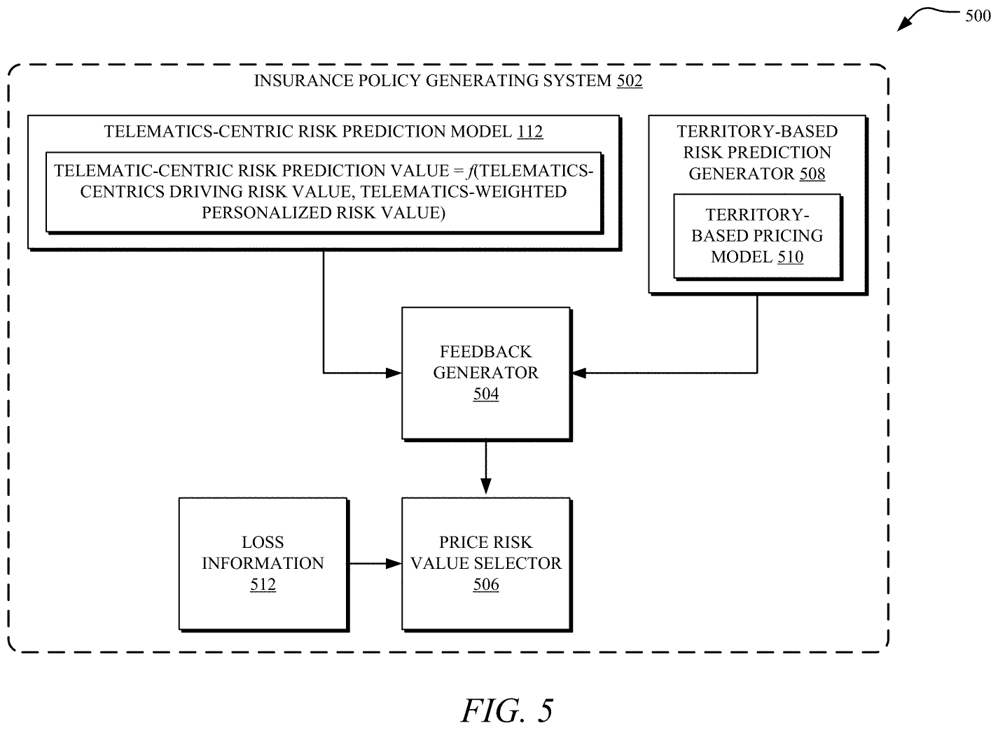

FIG. 5 illustrates an example system 500 including an insurance policy generating system 502 for generating telematic-centric insurance policies using the techniques discussed herein. The system 500 can include a feedback generator 504 and a price risk value selector 506 for providing feedback for the telematics-centric risk prediction model 112. As such, the system 500 improves the accuracy of the telematics-centric risk prediction model 112 in an iterative manner.

In some examples, the insurance policy generating system 502 includes the telematics-centric risk prediction model 112 which generates the telematics-centric risk prediction value 102 as a function of the telematics-centric driving risk value 108 and the telematics-weighted personalized risk value 110. The telematics-centric risk prediction value 102 can be a first risk prediction value and the insurance policy generating system 502 can also include a territory-based risk prediction generator 508 to generate a second risk prediction value. For instance, the territory-based risk prediction generator 508 can use a territory-based pricing model 510 to generate a territory-based risk prediction value and provide the territory-based risk prediction value to the feedback generator 504. The territory-based pricing model 510 determines various territory-based risk values for the specific individual 106 by assessing those factors with respect to other policy holders associated with the location, territory, and/or region of the specific individual 106. For instance, the territory-based pricing model 510 can generate the territory-based risk prediction value based on a driver classification associated with the specific individual 106; a household composition associated with the specific individual 106; a financial assessment of the specific individual 106; personal discounts associated with the specific individual 106, and/or other territory-based information relevant to calculating risk for the specific individual 106.

The feedback generator 504 can receive the telematics-centric risk prediction value 102 from the telematics-centric risk prediction model 112 and the territory-based risk prediction value from the territory-based risk prediction generator 508. The feedback generator 504 calculates a feedback ratio by dividing the territory-based risk prediction value (e.g., the second risk prediction value) by the telematics-centric risk prediction value 102 (e.g., the first risk prediction value). The price risk value selector 506 can select one of the telematics-centric risk prediction value 102 or the territory-based risk prediction value based on the feedback ratio and/or loss information 512 associated with the specific individual 106. For instance, if the feedback ratio is greater than one and the loss information 512 indicates no previous losses for the specific individual 106, the insurance policy generating system 502 selects the telematics-centric risk prediction value 102 for the insurance policy. If the feedback ratio is greater than one and the loss information 512 indicates one or more previous losses for the specific individual 106, the insurance policy generating system 502 selects the territory-based risk prediction value for the insurance policy. In contrast, if the feedback ratio is less than one and the loss information 512 indicates no previous losses for the specific individual 106, the insurance policy generating system 502 selects the territory-based risk prediction value for the insurance policy. If the feedback ratio is less than one and the loss information 512 indicates one or more previous losses for the specific individual 106, the insurance policy generating system 502 selects the telematics-centric risk prediction value 102 for the insurance policy. Moreover, correlations between the feedback ratio, the telematics data 104, the persona risk values (e.g., the telematics persona risk value 408, the household persona risk value 414, the behavioral persona risk value 420, and/or the finance persona risk value 426), and/or the risk factor values 204 can be identified, for instance, using the pattern recognition and machine learning techniques discussed above. As such, the insurance policy generating system 502 can be fine-tuned and improved as new correlations that substantially impact risk are identified.

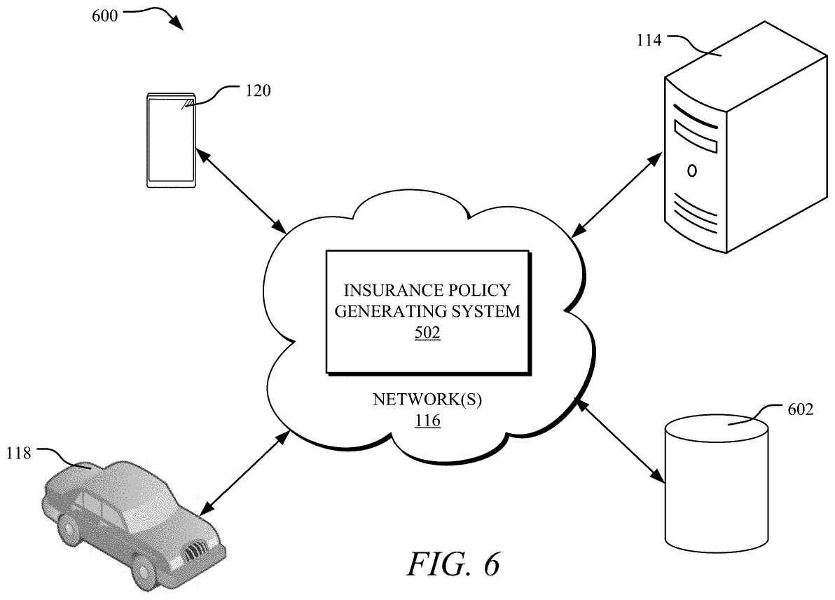

FIG. 6 illustrates an example network environment 600 for generating the telematics-centric risk prediction value 102 for an insurance policy using the systems 100-500 discussed herein. The example network environment 600 includes the one or more network(s) 116 which can be a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 116 can include any type of network, such as the Internet, an intranet, a Virtual Private Network (VPN), a Voice over Internet Protocol (VoIP) network, a wireless network (e.g., Bluetooth), a cellular network, a satellite network, combinations thereof, etc. The network(s) 116 provide access to and interactions with systems providing input to the insurance policy generating system 502, such as the mobile device 120 and/or a computing system at the vehicle 118. The network(s) 116 can include communications network components such as, but not limited to gateways routers, servers, and registrars, which enable communication across the network(s) 116. In one implementation, the communications network components include multiple ingress/egress routers, which may have one or more ports, in communication with the network(s) 116. Communication via any of the networks can be wired, wireless, or any combination thereof.

The insurance policy generating system 502 can also include at least one server device 114 hosting software, application(s), websites, and the like for receiving input data and analyzing the input data to generate the insurance policy. The insurance policy generating system 502 can receive inputs from various computing devices and transform the received input data into other unique types of data that capture (e.g., represent) telematics-related risk in a more granular and more accurate way. The server(s) 114 may be a single server, a plurality of servers with each such server being a physical server or a virtual machine, or a collection of both physical servers and virtual machines. In another implementation, a cloud hosts one or more components of the systems 100-500. The server(s) 114 may represent an instance among large instances of application servers in a cloud computing environment, a data center, or other computing environment. The server(s) 114 can access data stored at one or more database(s) 602 (e.g., including any of the values discussed herein). The systems 100-500, the server(s) 114, and/or other resources connected to the network(s) 116 may access one or more other servers to access other websites, applications, web services interfaces, storage devices, APIs, computing devices, or the like to perform the techniques discussed herein.

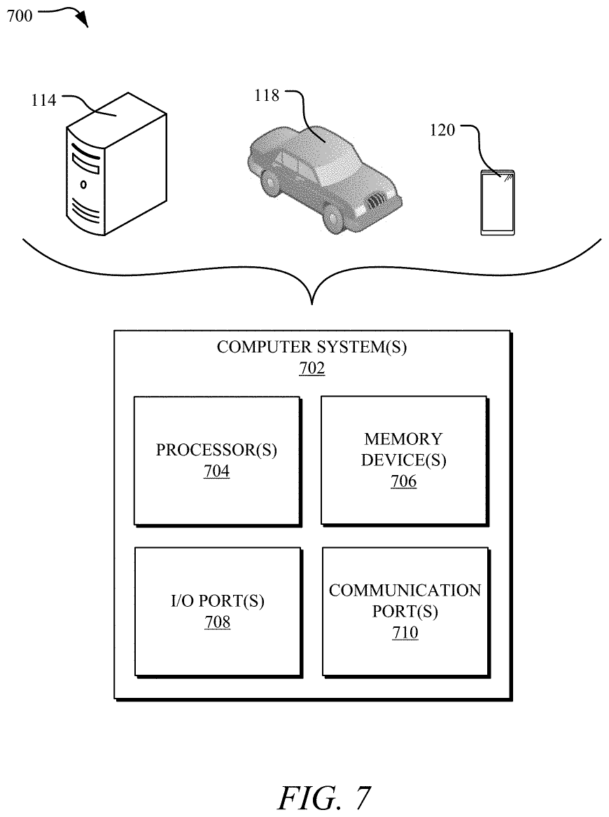

Turning to FIG. 7, an example network environment 700 includes one or more computing device(s) 702 for generating the telematics-based insurance policy with the insurance policy generating system 502. In one implementation, the one or more computing device(s) 702 include the one or more server device(s) 114, the computing device of the vehicle 118, the mobile device 120, and/or other computing devices associated with the specific individual 106 or the insurance provider to execute the insurance policy generating system 502 as a software application and/or a module or algorithmic component of software.

In some instances, the computing device(s) 702 can including a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device(s) 702 may be integrated with, form a part of, or otherwise be associated with the systems 100-500. It will be appreciated that specific implementations of these devices may be of differing possible specific computing architectures not all of which are specifically discussed herein but will be understood by those of ordinary skill in the art.

The computing device 702 may be a computing system capable of executing a computer program product to execute a computer process. Data and program files may be input to the computing device 702, which reads the files and executes the programs therein. Some of the elements of the computing device 702 include one or more hardware processors 704, one or more memory devices 706, and/or one or more ports, such as input/output (IO) port(s) 708 and communication port(s) 710. Additionally, other elements that will be recognized by those skilled in the art may be included in the computing device 702 but are not explicitly depicted in FIG. 7 or discussed further herein. Various elements of the computing device 702 may communicate with one another by way of the communication port(s) 710 and/or one or more communication buses, point-to-point communication paths, or other communication means.

The processor 704 may include, for example, a central processing unit (CPU), a microprocessor, a microcontroller, a digital signal processor (DSP), and/or one or more internal levels of cache. There may be one or more processors 704, such that the processor 704 comprises a single central-processing unit, or a plurality of processing units capable of executing instructions and performing operations in parallel with each other, commonly referred to as a parallel processing environment.

The computing device 702 may be a conventional computer, a distributed computer, or any other type of computer, such as one or more external computers made available via a cloud computing architecture. The presently described technology is optionally implemented in software stored on the data storage device(s) such as the memory device(s) 706, and/or communicated via one or more of the I/O port(s) 708 and the communication port(s) 710, thereby transforming the computing device 702 in FIG. 7 to a special purpose machine for implementing the operations described herein and generating the telematics-centric risk prediction value 102. Moreover, the computing device 702, as implemented in the systems 100-500, receives various types of input data and transforms the input data through various stages of the data flow into new types of data files (e.g., the risk factor values 204, the telematics persona risk value 408, the household persona risk value 414, the behavioral persona risk value 420, and/or the finance persona risk value 426). Moreover, these new data files are transformed further into the telematics-centric risk prediction value 102 which enables the computing device 702 to do something it could not do before, including generate a telematic-centric insurance policy.

The one or more memory device(s) 706 may include any non-volatile data storage device capable of storing data generated or employed within the computing device 702, such as computer executable instructions for performing a computer process, which may include instructions of both application programs and an operating system (OS) that manages the various components of the computing device 702. The memory device(s) 706 may include, without limitation, magnetic disk drives, optical disk drives, solid state drives (SSDs), flash drives, and the like. The memory device(s) 706 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 706 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 702 includes one or more ports, such as the I/O port(s) 708 and the communication port(s) 710, for communicating with other computing, network, or vehicle computing devices. It will be appreciated that the I/O port 708 and the communication port 710 may be combined or separate and that more or fewer ports may be included in the computing device 702.

The I/O port 708 may be connected to an I/O device, or other device, by which information is input to or output from the computing device 702. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 702 via the I/O port 708. Similarly, the output devices may convert electrical signals received from the computing device 702 via the I/O port 708 into signals that may be sensed as output by a human, such as sound, light, and/or touch. The input device may be an alphanumeric input device, including alphanumeric and other keys for communicating information and/or command selections to the processor 704 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 702 via the I/O port 708. For example, an electrical signal generated within the computing device 702 may be converted to another type of signal, and/or vice-versa. In one implementation, the environment transducer devices sense characteristics or aspects of an environment local to or remote from the computing device 702, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 702, such as, physical movement of some object (e.g., a mechanical actuator), heating or cooling of a substance, adding a chemical substance, and/or the like.

In one implementation, the communication port 710 is connected to the network 116 so the computing device 702 can receive network data useful in executing the methods and systems set out herein as well as transmitting information and network configuration changes determined thereby. Stated differently, the communication port 710 connects the computing device 702 to one or more communication interface devices configured to transmit and/or receive information between the computing device 702 and other devices (e.g., network devices of the network(s) 114) by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 710 may communicate with an antenna or other link for electromagnetic signal transmission and/or reception.

In an example the insurance policy generating system 502, the telematics-centric risk prediction model 112, and/or other software, modules, services, and operations discussed herein may be embodied by instructions stored on the memory devices 706 and executed by the processor 704.

The system set forth in FIG. 7 is but one possible example of a computing device 702 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 702.

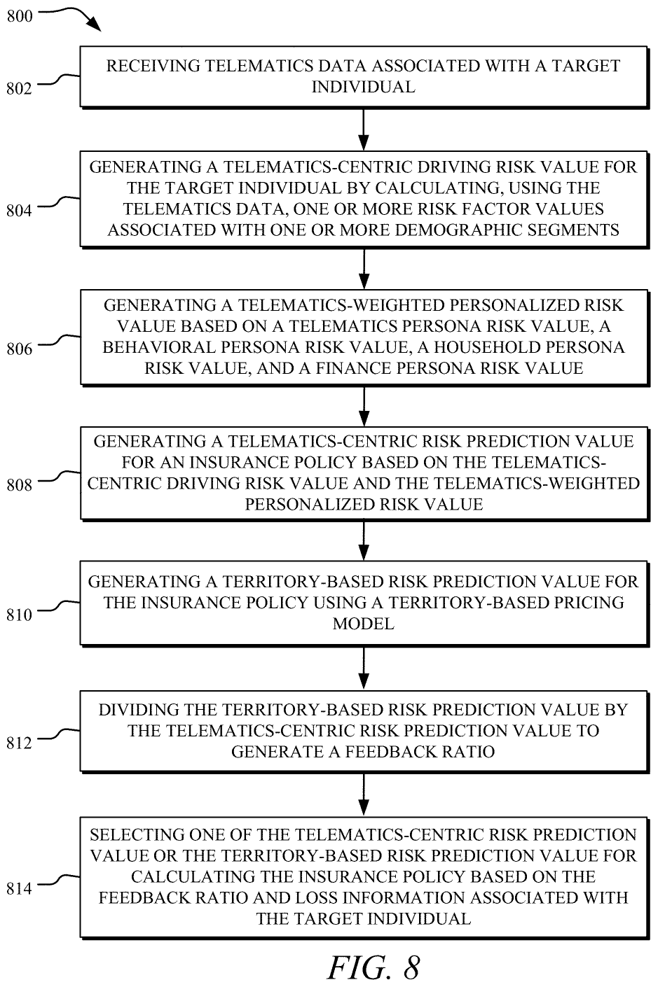

FIG. 8 depicts an example method 800 for generating the telematics-centric insurance policy, which can be performed by any of the systems 100-500 and/or network environments 600 and 700. At operation 802, the method 800 receives telematics data associated with a specific individual. At operation 804, the method 800 generates a telematics-centric driving risk value for the specific individual by calculating, using the telematics data, one or more risk factor values associated with one or more demographic segments. At operation 806, the method 800 generates a telematics-weighted personalized risk value based on a telematics persona risk value, a behavioral persona risk value, a household persona risk value, and a finance persona risk value. At operation 808, the method 800 generates a telematics-centric risk prediction value for an insurance policy based on the telematics-centric driving risk value and the telematics-weighted personalized risk value. At operation 810, the method 800 generates a territory-based risk prediction value for the insurance policy using a territory-based pricing model. At operation 812, the method 800 divides the territory-based risk prediction value by the telematics-centric risk prediction value to generate a feedback ratio. At operation 814, the method 800 selects one of the telematics-centric risk prediction value or the territory-based risk prediction value for calculating the insurance policy based on the feedback ratio and loss information associated with the specific individual.

It is to be understood that the specific order or hierarchy of operations in the methods depicted in FIG. 8 and throughout this disclosure are instances of example approaches and can be rearranged while remaining within the disclosed subject matter. For instance, any of the operations depicted in FIG. 8 may be omitted, repeated, performed in parallel, performed in a different order, and/or combined with any other of the operations depicted in FIG. 8 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for risk assessment, the method comprising:
obtaining telematics data associated with a specific individual, the telematics data captured using at least one telematics device;
generating a telematics-centric driving risk value for the specific individual by:
determining one or more demographic segments corresponding to the specific individual; and
calculating one or more risk factor values associated with the one or more demographic segments using the telematics data;
generating a telematics-weighted personalized risk value by:
determining one or more telematics metrics from the telematics data;
calculating a telematics persona risk value based on the one or more telematics metrics; and
calculating at least one of:
a behavioral persona risk value based on one or more behavioral metrics;
a household persona risk value based on one or more household metrics; or
a finance persona risk value based on one or more finance metrics; and
generating a telematics-centric risk prediction value based on the telematics-centric driving risk value and the telematics-weighted personalized risk value.

2. The method of claim 1, wherein calculating the one or more risk factor values further includes calculating:
a first risk factor value by comparing first community telematics data corresponding to a first demographic segment of the one or more demographic segments to the telematics data;
a second risk factor value by comparing second community telematics data corresponding to a second demographic segment of the one or more demographic segments to the telematics data;
a third risk factor value by comparing third community telematics data corresponding to a third demographic segment of the one or more demographic segments to the telematics data; and
a fourth risk factor value by comparing fourth community telematics data corresponding to a fourth demographic segment of the one or more demographic segments to the telematics data.

3. The method of claim 2, wherein:
the first demographic segment is an age;
the second demographic segment is a gender;
the third demographic segment is a marital status; and
the fourth demographic segment is an amount of driving experience.

4. The method of claim 1, wherein the one or more demographic segments are a plurality of demographic segments and calculating the one or more risk factor values further includes:
determining a demographic model of the specific individual based on the plurality of demographic segments;
determining community telematics data corresponding to the demographic model; and
calculating a risk factor value based on comparing the community telematics data to the telematics data.

5. The method of claim 4, wherein the plurality of demographic segments include at least two of an age, a gender, a marital status, or an amount of driving.

6. The method of claim 1, wherein the one or more telematics metrics include at least one of:
an amount of driving time;
an amount of idle time;
a driving schedule;
one or more locations of visits;
a preference for day time driving;
a preference for night time driving;
accidents-related data; or
violations-related data.

7. The method of claim 6, wherein the one or more behavioral metrics include at least one of:
interests data associated with the specific individual;
health data associated with the specific individual;
social network data associated with the specific individual; or
digital media interactions associated with the specific individual.

8. The method of claim 7, wherein the one or more household metrics include at least one of:
an age of a youngest driver associated with a household corresponding to the specific individual;
a number of drivers associated with the household;
a number of people associated with the household;
a male-to-female ratio associated with the household;
an education level associated with the household;
an income associated with the household; or
a number of cars associated with the household.

9. The method of claim 8, wherein the one or more finance metrics include at least one of:
an earnings value associated with the specific individual;
an expenses value associated with the specific individual; or
a credit score associated with the specific individual.

10. The method of claim 1, wherein the telematics device includes one or more vehicle sensors deployed at a vehicle associated with the specific individual.

11. The method of claim 1, further comprising:
generating a territory-based risk prediction value based on:
a region associated with the specific individual;
a driver classification associated with the specific individual;
a household composition associated with the specific individual; and
a financial assessment of the specific individual;
generating a feedback ratio by dividing the territory-based risk prediction value by the telematics-centric risk prediction value;
determining whether the feedback ratio is greater than a threshold;
determining whether a loss is associated with the specific individual; and
selecting one of the telematics-centric risk prediction value or the territory-based risk prediction value based at least partly on whether the feedback ratio is greater than the threshold and whether the loss is associated with the specific individual.

12. One or more tangible non-transitory computer-readable storage media storing computer-executable instructions for performing a computer process on a computing system, the computer process comprising:
determining telematics data associated with a specific individual;
generating a telematics-centric driving risk value for the specific individual by:
determining one or more demographic segments corresponding to the specific individual, the one or more demographic segments including at least one of an age or age range, a gender, a marital status, or an amount of driving experience; and
calculating one or more risk factor values associated with the one or more demographic segments using the telematics data;
generating a telematics-weighted personalized risk value based on a telematics persona risk value associated with the specific individual and at least one of:
a behavioral persona risk value;
a household persona risk value; or
a finance persona risk value; and
generating a telematics-centric risk prediction value based on the telematics-centric driving risk value and the telematics-weighted personalized risk value.

13. The one or more tangible non-transitory computer-readable storage media of claim 12, wherein calculating the plurality of risk factor values further comprises:
determining community telematics data corresponding to the plurality of demographic segments; and
comparing the telematics data associated with the specific individual to the community telematics data.

14. The one or more tangible non-transitory computer-readable storage media of claim 12, wherein the telematics persona risk value is calculated based on a plurality of telematics metrics including at least two of:
an amount of driving time;
an amount of idle time;
a driving schedule;
locations of visits;
a preference for day time driving;
a preference for night time driving;
accidents-related data; or
violations-related data.

15. The one or more tangible non-transitory computer-readable storage media of claim 12, the computer process further comprising:
generating a territory-based risk prediction value;
calculating a feedback ratio by dividing the territory-based risk prediction value by the telematics-centric risk prediction value;
determining whether the feedback ratio is greater than one; and
selecting one of the telematics-centric risk prediction value or the territory-based risk prediction value to use to calculate the insurance policy at least partly based on whether the feedback ratio is greater than one.

16. The one or more tangible non-transitory computer-readable storage media of claim 12, wherein the telematics data is received from at least one of:
one or more vehicle sensors installed at a vehicle associated with the specific individual; or
a global positioning systems (GPS) sensor of a mobile device associated with the specific individual.

17. A system for risk assessment, the system comprising:
at least one processor configured to:
obtain telematics data corresponding to a vehicle associated with a specific individual;
generate a telematics-centric driving risk value for the specific individual by:
determining one or more demographic segments corresponding to the specific individual, the one or more demographic segments including at least one of an age, a gender, a marital status, or an amount of driving experience; and
calculating one or more risk factor values corresponding to the plurality of demographic segments;
generate a telematics-weighted personalized risk value based on a telematics persona risk value associated with the specific individual and at least one of:
a behavioral persona risk value;
a household persona risk value; or
a finance persona risk value; and
generate a telematics risk prediction value by using the telematics-centric driving risk value and the telematics-weighted personalized risk value.

18. The system of claim 17, wherein the behavioral persona risk value is calculated based on a plurality of behavioral metrics including:
interests data associated with the specific individual;
health data associated with the specific individual;
social network data associated with the specific individual; and
digital media interactions associated with the specific individual.

19. The system of claim 17, wherein the household persona risk value is calculated based on a plurality of household metrics including at least one of:
an age of a youngest driver associated with a household corresponding to the specific individual;
a number of drivers associated with the household;
a number of people associated with the household;
a male-to-female ratio associated with the household;
an education level associated with the household;
an income associated with the household; or
a number of cars associated with the household.

20. The system of claim 17, wherein the finance persona risk value is calculated based on a plurality of finance metrics including:
an earnings value associated with the specific individual;
an expenses value associated with the specific individual; and
a credit score associated with the specific individual.
